(19) United States
(12) Patent Application Publication
(10) Pub. No.: US 2019/0143735 A1
(43) Pub. Date: May 16, 2019

(54) HIDDEN IMAGE SECURITY DEVICE AND METHOD

(71) Applicant: CCL SECURE PTY LTD, Craigieburn, Victoria (AU)

(72) Inventors: Gary Fairless Power, Craigieburn, Victoria (AU); Phei Lok, Craigieburn, Victoria (AU)

(73) Assignee: CCL SECURE PTY LTD, Craigieburn, Victoria (AU)

(21) Appl. No.: 15/689,999

(22) PCT Filed: Mar. 3, 2016
(86) PCT No.: PCT/AU2016/050138

§ 371 Date: Aug. 29, 2017

(30) Foreign Application Priority Data
Mar. 6, 2015 (AU) 2015100280
Mar. 6, 2015 (AU) 2015900803

(51) Int. Cl. B42D 25/328; B42D 25/364; B42D 25/29; B42D 25/41

(52) U.S. Cl. CPC B42D 25/328; B42D 25/41; B42D 25/29; B42D 25/364

(57) ABSTRACT

A method for producing an optical device, preferably a security device, including the steps of: forming a planar relief structure on a substantially planar first surface of a substrate, preferably a transparent substrate, the planar relief structure having a first alignment direction and including a plurality of relief structure elements each having the same height; and applying a liquid crystal polymer (LCP) layer onto the planar relief structure such that the LCP layer is aligned with the relief structure, wherein the LCP layer includes at least one or more first LCP regions having a first height and one or more second LCP regions having a second height above the substantially planar first surface of the substrate, wherein the second height is different to the first height, and an optical device formed by such a method.

### CROSS-REFERENCE TO RELATED APPLICATIONS

The present application is the U.S. national stage application of International Application PCT/AU2016/050138, filed Mar. 3, 2016, which international application was published on Sep. 15, 2016, as International Publication WO2016/141420. The International Application claims priority of Australian Patent Application No. 2015100280, filed Mar. 6, 2015, and Australian Patent Application No. 2015900803, filed Mar. 6, 2015, the contents of which are incorporated herein by reference in their entireties.

### FIELD OF THE INVENTION

The invention relates generally to the field of optical security devices, for example as used on banknotes.

### BACKGROUND TO THE INVENTION

It is well known that many of the world's banknotes, as well as other security documents, carry optical devices which act as security elements. Some optical security elements produce optical effects that vary depending on whether the optical security elements are viewed through a decoding screen or not. The incorporation of such optical security elements into security documents therefore acts as a deterrent against counterfeiting of the document.

Nevertheless, unscrupulous counterfeiting groups have become better organised and more technically competent, and the high returns from counterfeiting, in spite of the risks, have become more readily appreciated. Over recent years, attempts at simulation of genuine elements have become more and more successful. This problem is exacerbated by the fact that the authentication process for the banknote by members of the public has long been recognised as if any, time authenticating their banknotes, which makes it easier for simulations to pass through. Therefore, although it is difficult to reproduce the optical effect of an optical security element, it is easily possible to create a passable forgery that may appear, without proper inspection, similar to the optical effect.

It is known the liquid crystals include the property of being birefringent. Incident light onto a surface including liquid crystal material will experience different refractive indices depending on the polarisation of the incident light.

Australian patent no. 2005207096 teaches applying a liquid crystal layer to a relief structure, where the relief structure is formed on a non-planar surface. The liquid crystal layer is applied such that its outward facing surface is substantially flat, and thereby different regions of the liquid crystal layer have different thicknesses. Forming a liquid crystal layer onto a non-planar surface is relatively difficult for at least two reasons. First, it can be difficult to create a non-planar surface comprising a relief structure with sufficient difference in height in order to create different optical effects. Secondly, specialised equipment may be required in order to apply the liquid crystal layer correctly onto the non-planar surface, for example in adequate registration.

It is therefore an object of the present invention to provide an optical device and method for the formation thereof which addresses the limitations of the prior art.

### SUMMARY OF THE INVENTION

According to a first aspect of the present invention, there is provided a method for producing an optical device, including the steps of: forming a relief structure on a substantially planar first surface of a substrate, the relief structure having a first alignment direction and including a plurality of relief structure elements; and applying a liquid crystal polymer (LCP) layer onto the relief structure such that the LCP layer is aligned with the relief structure, wherein the LCP layer includes at least one or more first LCP regions having a first height and one or more second LCP regions having a second height above the substantially planar first surface of the substrate, wherein the second height is different to the first height.

Preferably, the substrate is transparent. Also, the optical device may be a security device.

Optionally, the, or each, first LCP region is associated with a first colour, and wherein the, or each, second LCP region is associated with a second colour, different to the first colour. The LCP layer may further include one or more third LCP regions having a third height, wherein the third height is different to both the first and the second heights. In this case, it is also preferable that the, or each, third LCP region is associated with a third colour, different to the first and second colours.

The method preferably includes the step of applying a high refractive index (HRI) layer onto the LCP layer. The HRI layer may extend past the edges of the LCP layer. Also, the HRI layer optionally includes a substantially flat outward facing surface. The HRI layer may be selected to have a refractive index the same as, or substantially the same as, the ordinary refractive index of the LCP layer. Alternatively, the HRI layer may be selected to have a refractive index the same as, or substantially the same as, the extraordinary refractive index of the LCP layer. In a further alternative, the HRI layer is selected to have a refractive index between the ordinary and extraordinary refractive indices of the LCP layer. In another configuration, however, the HRI layer may be selected to have a refractive index substantially greater than the largest refractive index of the LCP layer.

Preferably, the substrate includes an embossing layer, and the method includes an embossing step such that an embossing layer of the substrate is embossed to create the relief structure. The embossing layer may include a radiation curable ink, and the embossing step may therefore include embossing and curing the radiation curable ink, thereby forming the relief structure.

Optionally, the liquid crystal polymer layer is applied using a printing process, such as gravure printing, flexographic printing, silk screen printing, or inkjet printing.

The relief structure, in embodiments, corresponds to a non-diffractive grating, preferably at least with respect to visible wavelengths of light. However, in other embodiments the relief structure corresponds to a diffractive grating, preferably at least with respect to visible wavelengths of light. Each relief structure element may be longitudinally extending and arranged parallel to each other relief structure.

Preferably, the substrate is at least substantially transparent and the method includes the further step of forming a first linear polariser on a second surface of the substrate, opposite the LCP layer. The linear polariser may have a polarising direction aligned at substantially 45 degrees with respect to the first alignment direction.

In embodiments, the LCP layer includes one or more structured regions, wherein the, or each, structure region includes a grating profile formed on the outward facing surface of the LCP layer. The entire LCP layer may correspond to a structured region, or alternatively the relief structure may include one or more non-relief regions, and the structure regions may be located overlapping the one or more non-relief regions. Optionally, the grating profile is configured to provided a diffractive effect.

According to a second aspect of the invention, there is provided a method for producing a security document, preferably a banknote, including the step of providing a document substrate including, in a region of the document substrate, an optical device produced according to the method of the first aspect.

In an embodiment, the substrate of the optical device is different to the document substrate, and the optical device is formed separately and subsequently attached to the document substrate. In an alternative embodiment, the substrate of the optical device is the same as the document substrate.

The method preferably includes the step of applying a first opacifying layer to a side of the document substrate, the first opacifying layer including a window region such that the optical device is located in the window region. Also, preferably, the method includes the step of applying a second opacifying layer to a different side of the document substrate to the first opacifying layer, the second opacifying layer including a window region such that the optical device is located in the window region, such that the optical device is located in a window of the security document. Alternatively, the method includes the step of applying a second opacifying layer to a different side of the document substrate to the first opacifying layer, the second opacifying layer partially or entirely covering the optical device, such that the optical device is located in a half-window of the security document.

The method may also include the step of providing a polariser in a region of the document substrate different to the location of the optical device, such that the optical device can be viewed through the polariser by twisting, folding, or other manipulation of the document substrate.

According to a third aspect of the present invention, there is provided an optical device, such as a security device, including a relief structure on a substantially planar first surface of a substrate, the relief structure having a first alignment direction and including a plurality of relief structure elements and a liquid crystal polymer (LCP) layer applied to the relief structure such that the LCP layer is aligned with the relief structure, wherein the LCP layer includes at least one or more first LCP regions having a first height and one or more second LCP regions having a second height above the substantially planar first surface of the substrate, wherein the second height is different to the first height. Preferably the substrate is transparent.

Optionally, the, or each, first LCP region is associated with a first colour, and wherein the, or each, second LCP region is associated with a second colour, different to the first colour. The LCP layer may further include one or more third LCP regions having a third height, wherein the third height is different to both the first and the second heights. In this case, it is also preferable that the, or each, third LCP region is associated with a third colour, different to the first and second colours.

Preferably, the optical device includes a high refractive index (HRI) layer applied to the LCP layer. The HRI layer may extend past the edges of the LCP layer. Also, the HRI layer optionally includes a substantially flat outward facing surface. The HRI layer may be selected to have a refractive index the same as, or substantially the same as, the ordinary refractive index of the LCP layer. Alternatively, the HRI layer may be selected to have a refractive index the same as, or substantially the same as, the extraordinary refractive index of the LCP layer. In a further alternative, the HRI layer may be selected to have a refractive index between the ordinary and extraordinary refractive indices of the LCP layer. In another configuration, however, the HRI layer is selected to have a refractive index substantially greater than the largest refractive index of the LCP layer.

Preferably, the substrate includes an embossing layer corresponding to the relief structure. The embossing layer may include a radiation curable ink.

Optionally, the liquid crystal polymer layer is applied using a printing process, such as gravure printing, intaglio printing, offset printing, silk screen printing, or inkjet printing.

The relief structure, in an embodiment, corresponds to a non-diffractive grating, preferably at least with respect to visible wavelengths of light. However, in another embodiment, the relief structure corresponds to a diffractive grating, preferably at least with respect to visible wavelengths of light. Each relief structure element may be longitudinally extending and arranged parallel each other relief structure.

Preferably, the substrate is transparent and the optical device includes a first linear polariser located on a second surface of the substrate, opposite the LCP layer. The first linear polariser may have a polarising direction aligned at substantially 45 degrees with respect to the first alignment direction.

In embodiments, the LCP layer includes one or more structured regions, wherein the, or each, structure region includes a grating profile formed on the outward facing surface of the LCP layer. The entire LCP layer may correspond to a structured region. Alternatively, the relief structure may include one or more non-relief regions, and wherein the structured regions are located overlapping the, or each of the, one or more non-relief regions. Optionally, the grating profile is configured to provide a diffractive effect.

According to a fourth aspect of the present invention, there is provided a security document, preferably a banknote, including a document substrate including, in a region of the document substrate, an optical device according to the third aspect.

In an embodiment, the substrate of the optical device is different to the document substrate, and wherein the optical device is formed separately and subsequently attached to the document substrate. In an alternative embodiment, the substrate of the optical device is the same as the document substrate.

The security document preferably includes a first opacifying layer applied to a side of the document substrate, the first opacifying layer including a window region such that the optical device is located in the window region.

Also preferably, the security document includes a second opacifying layer applied to a different side of the document substrate to the first opacifying layer, the second opacifying layer including a window region such that the optical device is located in the window region, such that the optical device is located in a window of the security document. Alternatively, the security document includes a second opacifying layer applied to a different side of the document substrate to the first opacifying layer, the second opacifying layer partially or entirely covering the optical device, such that the optical device is located in a half-window of the security document.

The security document may also include a polariser formed in a region of the document substrate different to the location of the optical device, such that the optical device can be viewed through the polariser by twisting, folding, or other manipulation of the document substrate.

The present invention advantageously provides for an optical device and method for the formation of such a device with a liquid crystal polymer layer having different heights, formed onto a surface of a substrate which is substantially planar, thereby avoiding the need to create a non-planar surface onto which a liquid crystal layer is applied.

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Refractive Index n

The refractive index of a medium n is the ratio of the speed of light in vacuum to the speed of light in the medium. The refractive index n of a lens determines the amount by which light rays reaching the lens surface will be refracted, according to Snell's law:

n₁*Sin (α)=n*Sin (θ),

where [symbol] is the angle between an incident ray and the normal at the point of incidence at the lens surface [symbol] is the angle between the refracted ray and the normal at the point of incidence, and n₁ is the refractive index of air (as an approximation n₁ may be taken to be 1).

### Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. In some processes, partial curing is performed before the radiation curable ink is embossed, but it is also possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1 shows a security document including a security device;

FIG. 2a shows a step of an embossing process for producing a security device;

FIG. 2b shows a step of an embossing process for producing a security device;

FIG. 3 shows an embossed side of a security device;

FIG. 4 shows a liquid crystal polymer (LCP) layer applied to the embossed side of the security device;

FIG. 5a shows the LCP layer including equal sized LCP regions of different heights;

FIG. 5b shows the LCP layer including different sized LCP regions of different heights;

FIG. 5c shows an arrangement of LCP regions of the LCP layer;

FIG. 6 shows the LCP layer covered by a high refractive index (HRI) material layer;

FIG. 7a shows the appearance of the security device under normal viewing conditions and under special viewing conditions;

FIG. 7b shows an arrangement for viewing a hidden image according to an embodiment;

FIG. 7c shows an arrangement for viewing a hidden image according to another embodiment;

FIG. 7d shows an arrangement for viewing a hidden image according to another embodiment;

FIG. 8 shows an arrangement including an input polariser, a LCP layer, and an output polariser;

FIG. 9 shows the development of the polarisation of an incident linearly polarised light for distances through the LCP layer;

FIG. 10 shows the development of the polarisation of an incident linearly polarised light, and the output polarisation and intensity for differently orientated output polarises, for distances through the LCP layer;

FIG. 11 shows the output intensity for different distances of LCP layer for two different wavelengths;

FIG. 12 shows a two-colour image formed by an arrangement of LCP regions;

FIG. 13a shows a LCP layer including a structured surface covering the entire outward facing surface of the LCP layer; and

FIG. 13b shows a LCP layer including a structured surface covering portions of the outward facing surface of the LCP layer.

### DESCRIPTION OF PREFERRED EMBODIMENT

For the purposes of the following discussion, the figures are to be considered illustrative and not to scale, unless otherwise indicated. The figures illustrate simplified depictions of the embodiments described.

A “polarising filter” as used herein can be selected from: structural polarisers as described in AU 2011100315; liquid crystal polarisers as described in AU 2012100299; or any other suitable polariser. An “integral polariser” is a polariser formed as part of a security device, for example as formed on a side of a security device.

“Incident light” is light from a light source incident onto a side of the substrate, and is in general considered to be non-polarised white light (for example, as sourced from an incandescent or fluorescent light source), unless otherwise stated.

A “visual effect” is an image, pattern, or other visually identifiable effect. A visual effect can be a hidden visual effect, which is only visible under certain conditions, or an overt visual effect, which is visible under normal viewing conditions. A visual effect can also be a diffractive visual effect or a non-diffractive visual effect.

A “verification polariser” is a polariser located separately to an optical device, for example a polariser formed as part of a security document or a polariser formed or supplied separately to a security document.

“Colour” as used herein refers to a colour as perceived, and may correspond to a single range of wavelengths or a mixing of different ranges of wavelengths.

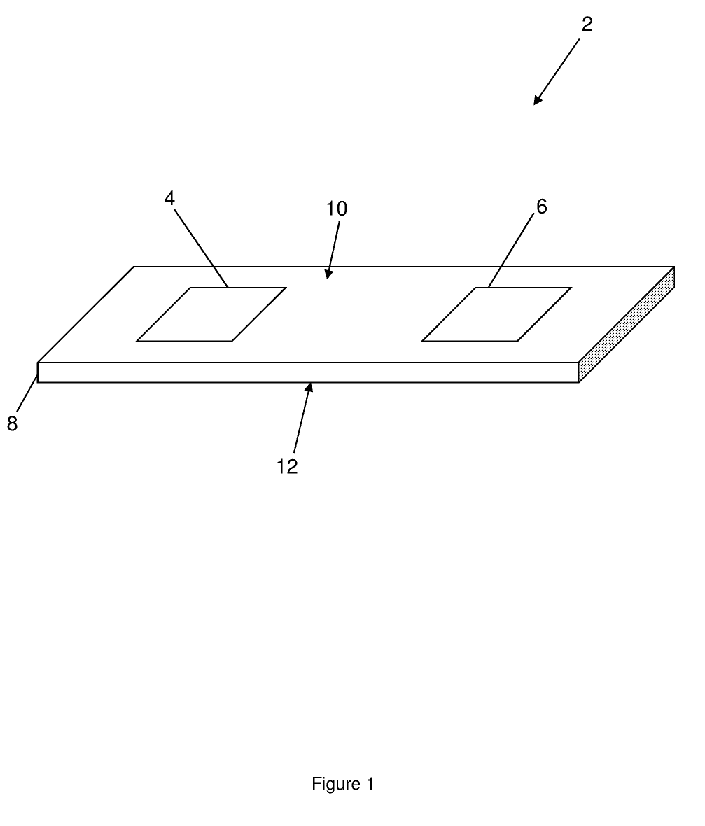

Referring to FIG. 1, a security document 2 includes an optical device 4 and verification polariser 6. The security document 2 includes a substrate 8 including a first surface 10 and a second surface 12. The first surface 10 and/or the second surface 12 can include an opacifying layer. The opacifying layer can have provided (e.g. printed) onto it designs and/or patterns and/or solid colours and/or text, etc. Further, one or both of the opacifying layers can include a window region corresponding to the optical device 4. Where only one opacifying layer includes a window region corresponding to the optical device 4, the optical device 4 is located within a half-window region of the security document 2. Where both opacifying layers include a window region corresponding to the location of the optical device 4, the optical device 4 is located within a full window region. The optical device 4 also includes a substrate, which can be the same substrate 8 as the whole of the security document 2 (as is assumed herein). In other embodiments, the optical device 4 is formed, for example, as a transfer film for applying to the substrate 8 of the security document 2.

In the embodiments described herein, the optical device 4 provides a security function in respect of the security document 2, and is interchangeably referred to with “security device 4”.

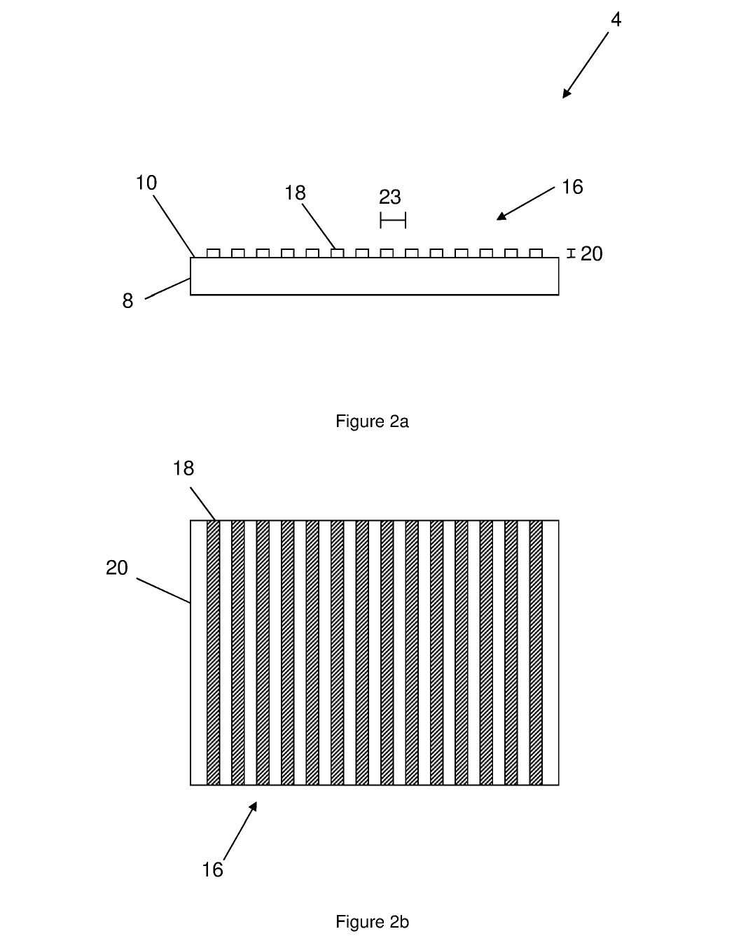

FIGS. 2a and 2b show a side-view (FIG. 2a) and a top-down view (FIG. 2b) of the first surface 10 of the substrate 8 in the region of the optical device 4. The first surface 10 of the substrate 8 is substantially planar and includes an alignment layer 20 formed onto it, defining an embossed relief structure 16. The relief structure 16 acts as an alignment grating 16. The first surface 10 may include alignment regions and non-alignment regions. The substrate 8 includes an embossing layer, where the embossing layer can either be the substrate 8 (or a portion of the substrate 8) or a layer applied to the substrate 8. In the latter case, the embossing layer can include a radiation curable ink, for example a UV curable ink. During the embossing process, or shortly after, the radiation curable ink is illuminated with radiation, for example UV radiation, which causes the radiation curable ink to cure.

The alignment grating 16 includes grating elements 18, each grating element 18 corresponding to peaks extending from the first surface 10 and extending longitudinally and parallel to one another. Alternatively, the grating elements 18 can correspond to a depression in the embossing layer 14. In an embodiment, each grating element 18 has an identical width or substantially the same width (for example, the same taking into account variation due to resolution of the embossing process). For example, each grating element 18 width is identical, and the grating spacing 23, being the spacing between identical points on adjacent grating elements 18, is equal to twice the width of a grating element 18.

According to an embodiment, the grating spacing 23 is selected such that the grating 16 does not create a diffractive effect, or any diffractive effect is sufficiently small to not interfere with operation of the optical device 4. However, it is envisioned that a diffractive effect can be incorporated into the overall visual effect, and therefore alternatively the grating elements 18 can be configured to provide a diffractive visual effect as well as the visual effect herein described (i.e. the grating spacing can be of the order of the wavelengths of visible light).

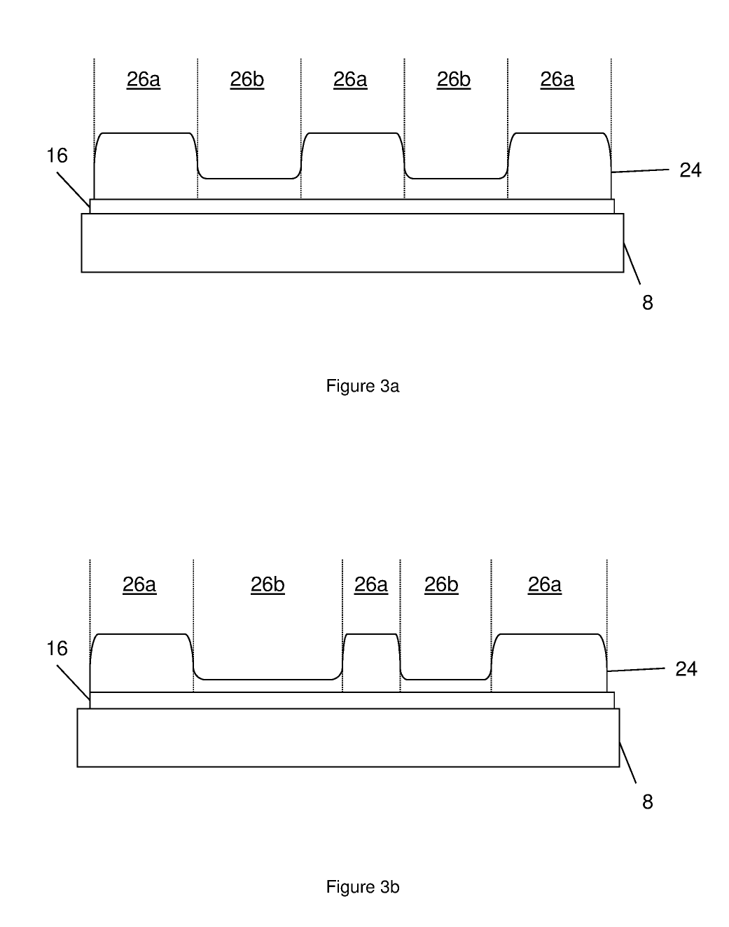

Referring to FIGS. 3a and 3b, a liquid crystal polymer (LCP) is applied onto the relief structure 16, thereby forming an LCP layer 24. The LCP can be applied using printing techniques. Example printing techniques include inkjet printing, gravure printing and intaglio printing. The LCP layer 24 is then fixed, for example through heat and/or radiation based curing. When fixed, the liquid crystal molecules are fixed in position and aligned substantially parallel to the underlying grating alignment direction.

The LCP layer 24 includes a plurality of LCP regions 26a, 26b. For the purposes of this disclosure, embodiments are described primarily utilising two types LCP regions (first LCP regions 26a, and second LCP regions 26b) unless otherwise stated. It is noted, however, that in general more than two different types of LCP regions 26 can be employed. There are one or more of each type of LCP region 26a, 26b, and each type is associated with a particular unique height (or thickness) of the LCP layer 24. FIGS. 3a and 3b show the LCP layer 24 having three first LCP regions 26a and two second LCP regions 26b. In an embodiment, the LCP layer 24 is fixed simultaneously with printing.

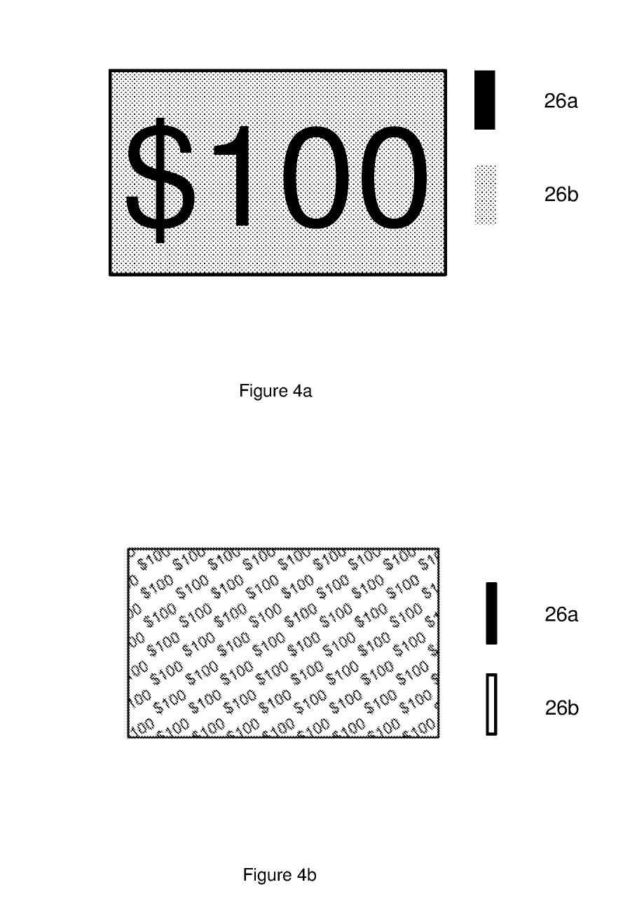

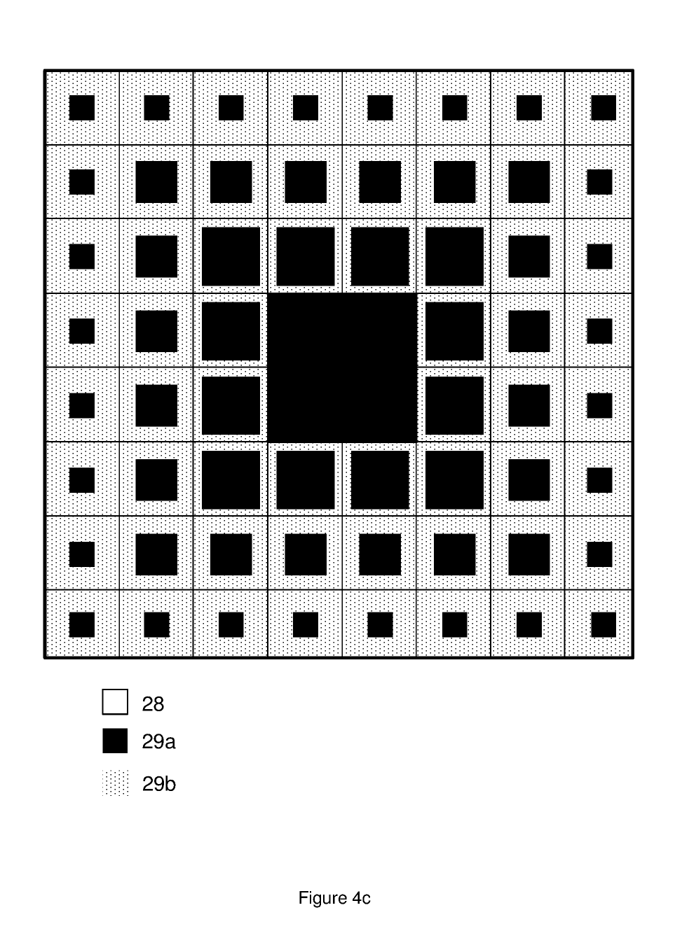

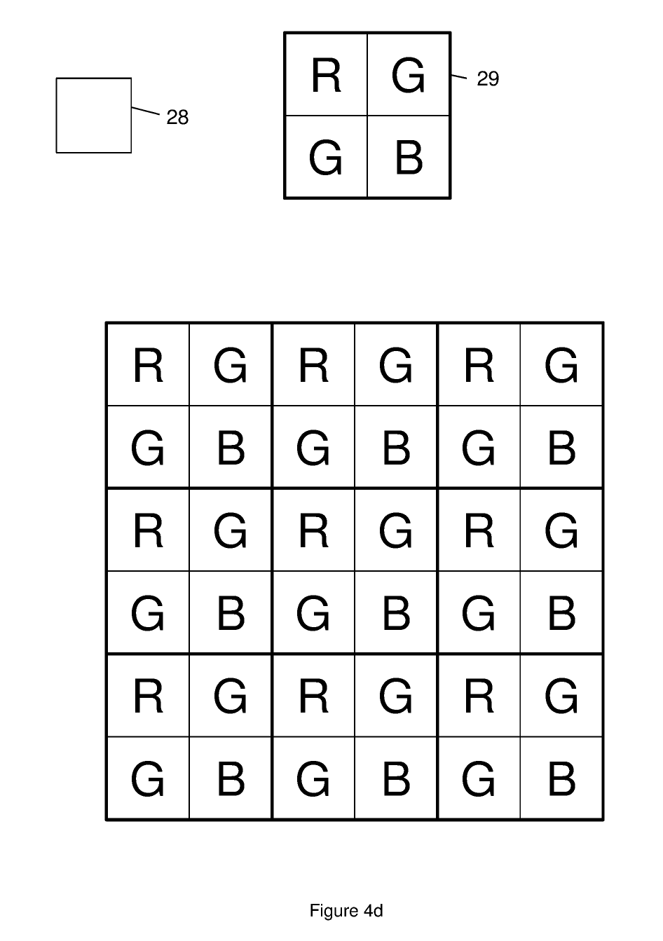

The LCP regions 26a, 26b can be arranged in a number of ways in order to form an image, for example an image corresponding to a macro-image (FIG. 4a), or an image corresponding to an array of microimages (FIG. 4b).

In an embodiment, the LCP regions 26a, 26b are arranged such that the first LCP regions 26a define an image, or a plurality of images, and the second LCP regions 26b define a background. In FIG. 4a, the first LCP regions 26a define the image “$100”, and the second LCP regions 26b define the background to the image. In FIG. 4b, the first LCP regions 26a define microimages (corresponding to repetitions of “$100”), and one again the second LCP regions 26b define the background to the microimages.

In another embodiment, the LCP regions 26a, 26b define pixels 28, and are therefore regularly arranged on the surface of the substrate.

In one configuration, each pixel 28 has an associated brightness. This can be achieved, as shown in FIG. 4c, by modifying the underlying relief structure for each pixel to be composed of a region including grating elements 18 (grating region 29a) and/or a region excluding grating elements 18 (non-grating region 29b). For each pixel 28, the associated brightness corresponds to the ratio of the area of the grating region 29a to the area of non-grating region 29b. Maximum intensity for a pixel 28 corresponds to the entire pixel 28 being associated with grating region 29a, and minimum intensity for a pixel 28 corresponds to the entire pixel 28 being associated with non-grating region 29b.

Referring to FIG. 4d, an example is shown wherein the colour of each pixel 28 is selected from red (R), green (G), and blue (B)—that is, there are three types of LCP region 26a, 26b, 26c. The pixels 28 are arranged such that there is a repeating pattern of each colour. In this manner, an RGB image can be created, wherein each pixel 28 acts as a sub-pixel of a larger composite pixel 29. The apparent colour of each composite pixel 29 is based on the relative intensities of each pixel 28. It is shown that there are two green sub-pixels for each blue and red sub-pixel; however this is merely an example.

In another configuration, the two LCP regions 26a, 26b are arranged according to create a halftone image. For this purpose, the first LCP region 26a is configured as the “foreground” colour, and the second LCP region 26b is configured as the “background” colour. Known methods for creating halftone images can be utilised.

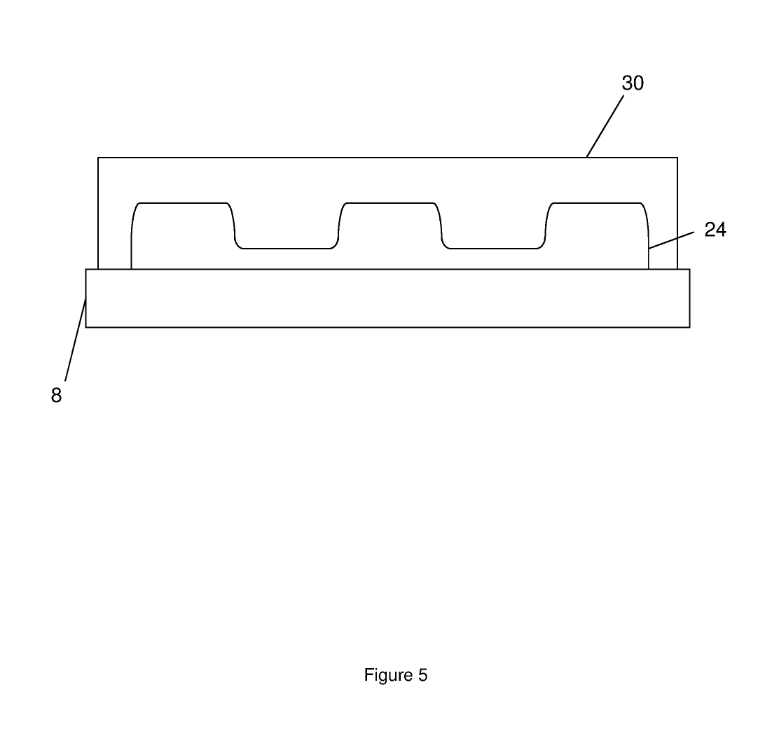

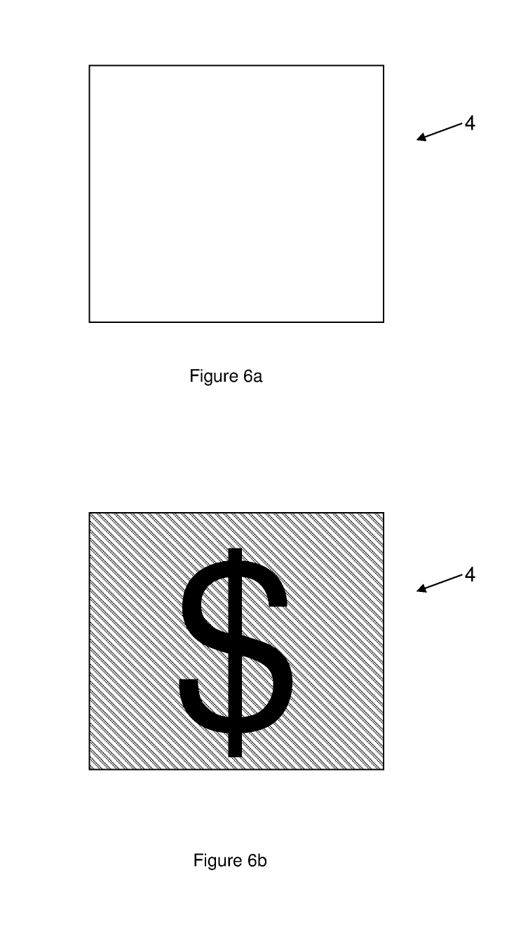

In an embodiment, referring to FIG. 5, a high refractive index (HRI) layer 30 is then applied onto the LCP layer 24. The HRI layer 30 can be applied to a uniform, or substantially uniform (for example, uniform apart from small variations due to the printing process), height above the substrate 8 surface. The HRI layer 30 can extend past the sides of the LCP layer 24 as shown in FIG. 6, providing a protective coating for the LCP layer 24. The HRI layer 30 can either be reflective or transmissive. When reflective, the LCP layer 24 is only visible through the substrate 8, and therefore the optical device 4 should be located within a transparent region of the substrate 8 (i.e. within a window region). When transmissive, the LCP layer 24 can be viewable through the substrate 8 and/or directly (through the HRI layer 30), depending on whether the optical device 4 is located within a full window or half-window region. In another configuration, the HRI layer 30 is transparent and a reflective surface is applied to the outward facing surface of the HRI layer 30 or to the opposite side of the substrate to the HRI layer 30. The HRI layer 30 can be applied using a known printing process, for example gravure printing.

In an embodiment, the HRI layer 30 is selected to have a refractive index the same as, or close to, a refractive index of the LCP layer 24. As the LCP layer 24 is birefringent, the refractive index can be selected to be close to the ordinary refractive index, the extraordinary refractive index, or a refractive index between these refractive indices. For example the refractive index of the HRI layer 30 is the mean of the two LCP layer 24 refractive indices. In this embodiment, the arrangement of the LCP regions 26a, 26b is not readily discernible when viewed without polarisers (described below). The HRI layer 30 acts to both physically and optically “smooth out” the height differences of the LCP layer 24, and therefore presenting a surface with no apparent overt visual effect when viewed without polarisers.

In an alternative embodiment, the HRI layer 30 is selected to have a refractive index sufficiently different to (for example, larger than) the refractive indices of the LCP layer 24 to allow for the arrangement (but not the colour) of LCP regions 26a, 26b to be visible without the use of polarisers.

In yet another embodiment, there can also be areas of the security device where the arrangement the different LCP regions 26a, 26b is discernible and areas where the arrangement of the different LCP regions 26a, 26b is not discernible. In order to achieve this, the HRI application process includes the application of two (or more) different HRI materials, each covering a different part of the LCP layer 24.

In use, the optical device 4 appears different when viewed under normal viewing conditions, and when viewed through one or more polarisers (the required number of polarisers will depend on the embodiment).

Various embodiments will now be described. In general, each embodiment includes one or more polarising filters (linear polarisers). An “input polariser” is a linear polariser receiving incident unpolarised light and transmitting polarised light towards the LCP layer 24. An “output polariser” is a linear polariser receiving transmitted light from the LCP layer 24 and transmitting the light to a user (or other viewer such as a camera). The input polariser and output polariser can be the same linear polariser (e.g. where the optical device 4 includes reflective surface) or different linear polarisers. In some configurations, a reflective layer is used in conjunction with the LCP layer 24 to provide a reflective effect.

Referring to FIGS. 6a and 6b, the appearance of the optical device 4 when viewed without corresponding one or more polarisers 38 (FIG. 6a) and when viewed with corresponding one or more polarisers 40 (FIG. 6b), is shown. The appearance of the optical device 4 in the latter case corresponds to a hidden visual effect.

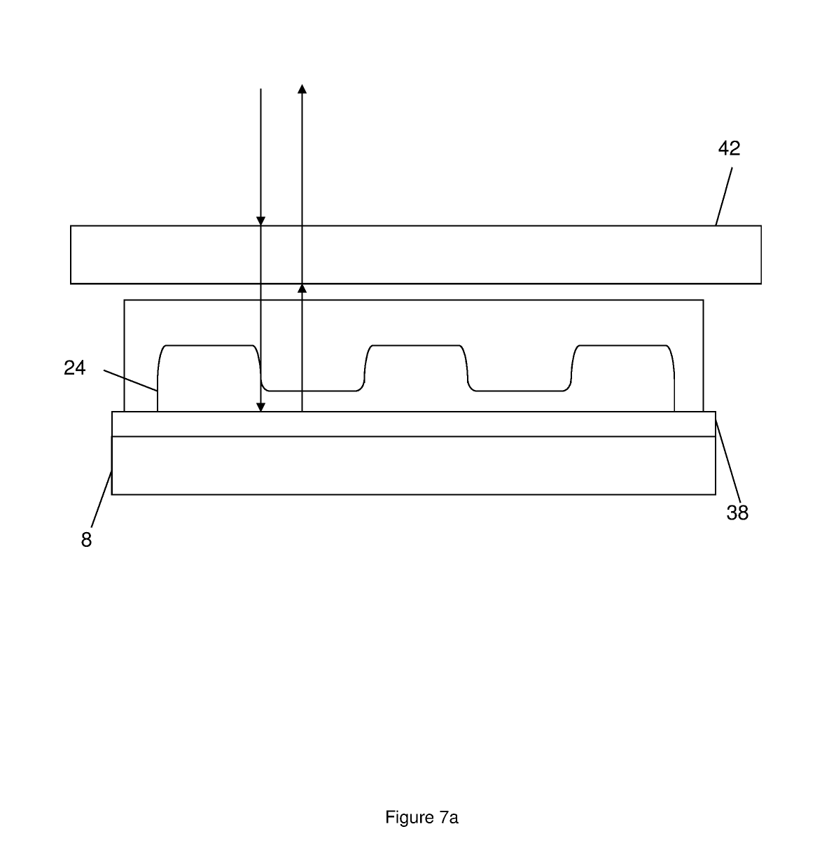

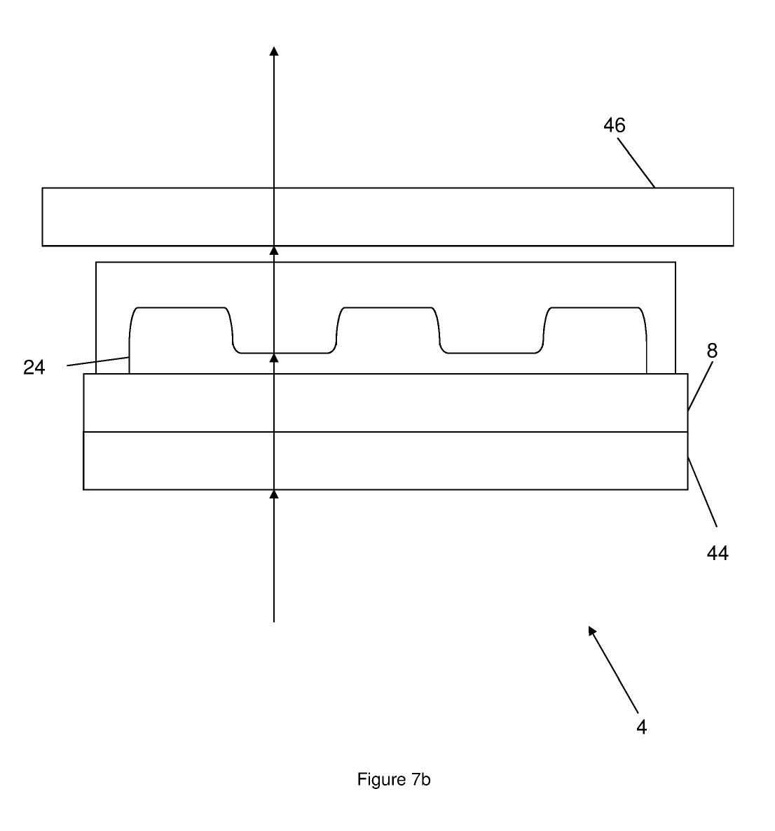

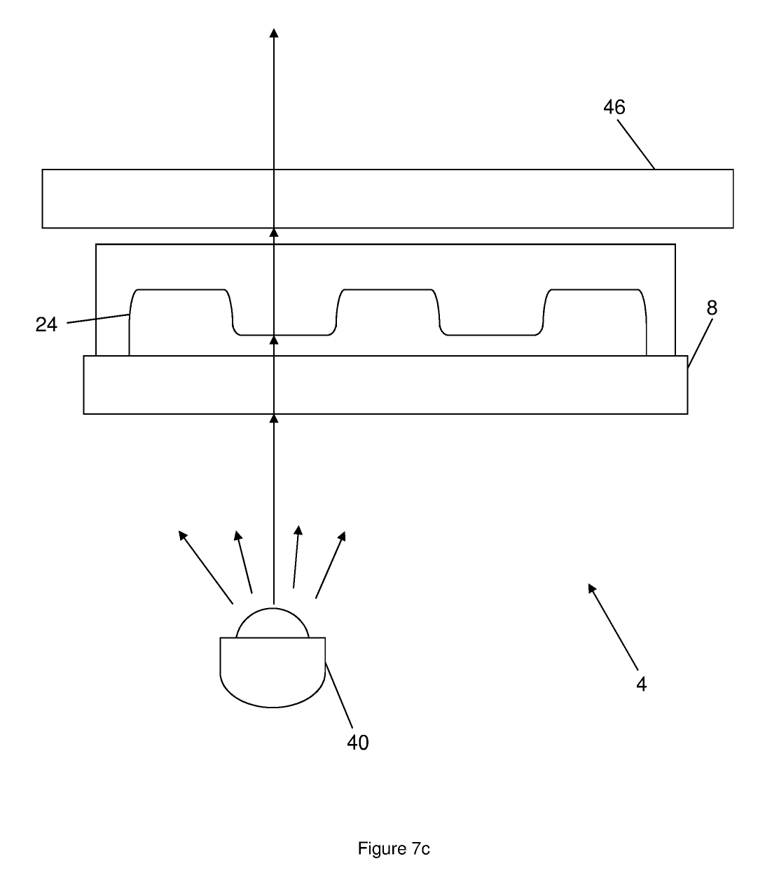

In the embodiment of FIG. 7a, in order to view the hidden visual effect, the LCP layer 24 is viewed through a single polariser 42, acting as both the input and the output polariser. In this arrangement, there is included a reflective layer 38 between the substrate 8 and the LCP layer 24 (as shown), or alternatively the reflective layer 38 can be located on the second surface 12 of the (transparent) substrate 8 to the LCP layer 24 (not shown). The reflective layer 38 can correspond to the embossing layer, a separate layer applied to the embossing layer or the substrate 8 before the application of the LCP layer 24, or a reflective layer applied to the opposite side of the substrate 8 to the LCP layer 24.

In the embodiments of FIGS. 7b and 7c, a polarised light source is required in order to view the hidden visual effect. Referring to FIG. 7b, this is achieved by placing a first polariser 44 onto the opposite side of the substrate 8 to the LCP layer 24, either by incorporating the first polariser 44 onto the substrate 8 during construction of the optical device 4, or by placing a separate polarising filter (for example, a polarising filter located in a different region of the security document 2) over the second surface 12. In this instance, the first polariser 44 acts as the input polariser. Referring to FIG. 7c, the polarised light source is instead a polarised lamp 40.

In order to view the hidden visual effect, a second polarising filter 46 is positioned over the LCP layer 24. The second polariser 46 can be the verification polariser 6 of FIG. 1, which can be positioned over the LCP layer 24 by folding the security document 2. In these embodiments, the second polarising filter 46 is not fixed to the security device 4, and must be positioned overlapping the security device 4 manually (for example, by a user).

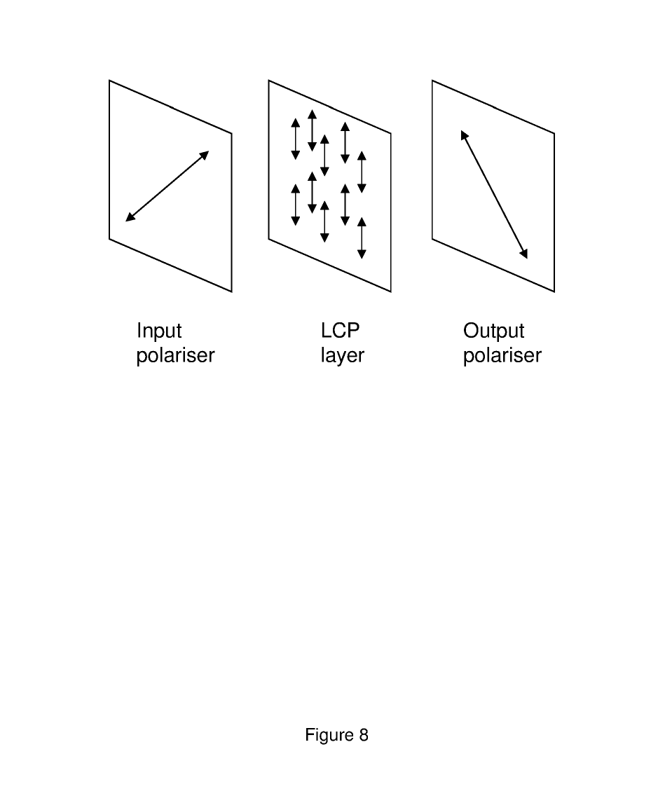

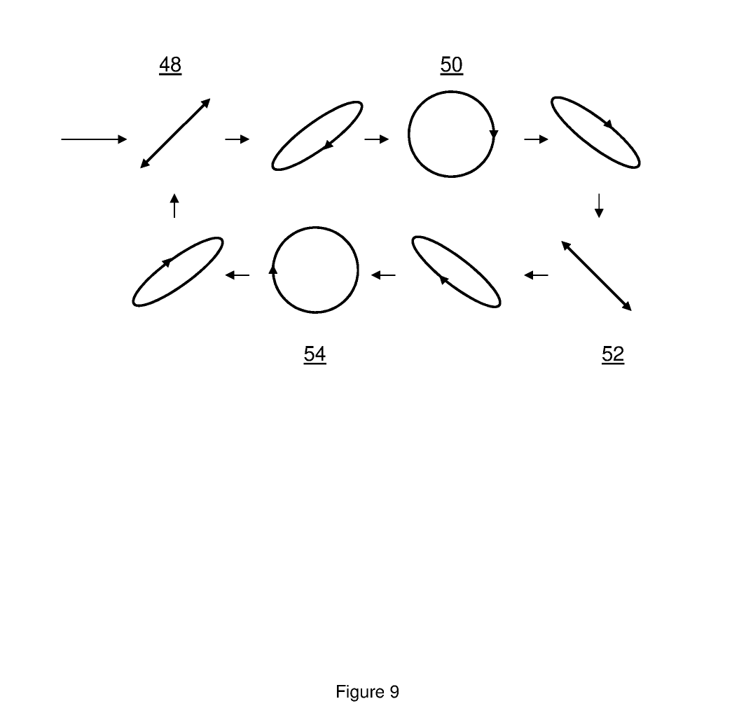

In general, an input polariser (whether it is a first or second polariser 44, 46) should have a polarisation direction neither perpendicular nor parallel to the alignment direction of the LCP layer 24. It is often preferable to have the polarisation direction of the input polariser aligned at substantially 45 degrees with respect to the alignment direction of the LCP layer 24 (as shown in FIG. 8). For two-way arrangements (where an optical effect can be seen when either side of the security device 4 is viewed) it is usually preferable to have both polarisers 44, 46 arranged with a polarisation direction aligned at substantially 45 degrees with respect to the alignment direction of the LCP layer 24. In this case, the polarisation directions of the polarisers 44, 46 can be perpendicular (as shown in FIG. 8) or parallel (not shown) to one another.

FIG. 9 shows the effect on the polarisation of incident linearly polarised light (e.g. after passing through an input polariser), where the polarisation direction of the incident light is rotated by 45 degrees with respect to the alignment direction of the LCP layer 24. The polarisation of the incident light changes between linearly polarised light 48 and circularly polarised light 50 as the light travels through the LCP layer 24. This is due to the birefringent property of the LCP layer 24. As shown, the incident light will continuously change from linearly polarised light in a first direction 48 (e.g. equal to the polarisation direction of the input polariser), circular polarisation of a first handedness 50, linear polarisation in a second direction 52 perpendicular to the first direction 48, and circular polarisation of a second handedness 54, opposite to the first handedness 50. This process will continue until the light exits the LCP layer 24.

When implemented as a reflective optical device 4, (for example as shown in FIG. 7a), incident, unpolarised light is linearly polarised by single polariser 42. The light then travels through the LCP layer 24, before reflecting off the reflective layer 36 and travelling back through the LCP layer 24. In this way, the total minimum distance that the light travels through the LCP layer 24 is twice the thickness of the LCP layer 24.

When implemented as a transmission optical device 4, the same effect on the incident light as for the reflective optical device 4 is found, however the path length is equal to the thickness of the LCP layer 24.

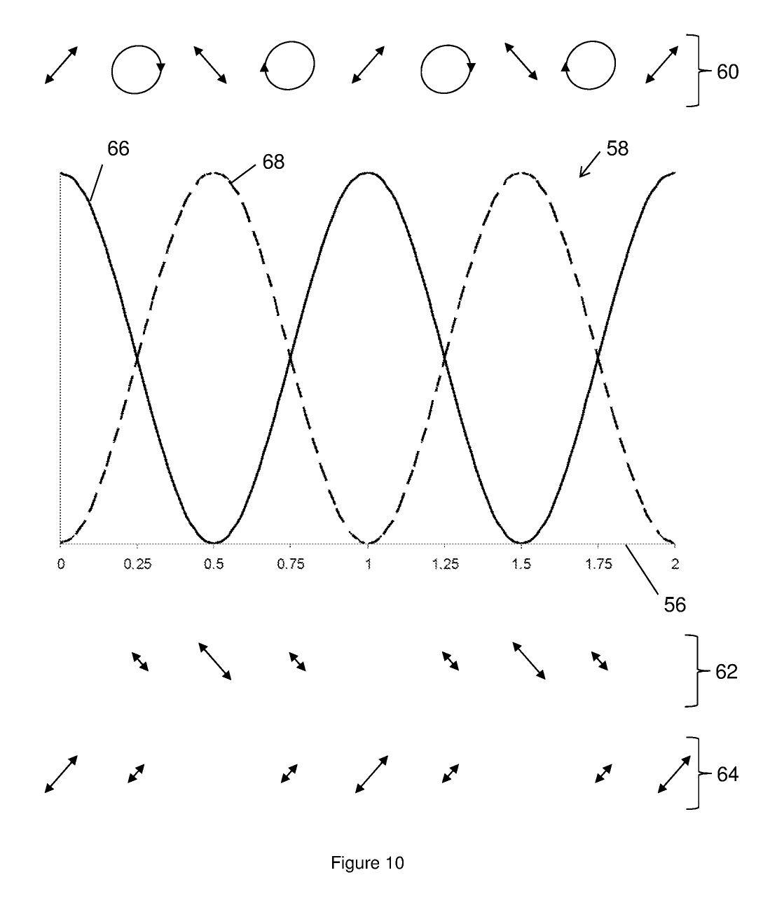

The effect on initially linearly polarised monochromatic light (i.e. light of one wavelength) travelling through the LCP layer 24 is shown in FIG. 10. The x-axis 56 of the diagram 58 corresponds to the distance travelled through the LCP layer 24, with a unit of 1 equal to a distance corresponding to a complete cycle of polarisation change (i.e. the polarisation at a distance of 1 is equal to the input polarisation). This distance is different for different wavelengths of light. The top series 60 shows the polarisation of the light at each distance through the LCP layer 24. The solid line 66 and the first bottom series 62 show the relative output intensity for an output polariser parallel to the input polariser (which includes a reflection mode device). The dashed line 68 and the second bottom series 64 show the relative output intensity for an output polariser perpendicular to the input polariser.

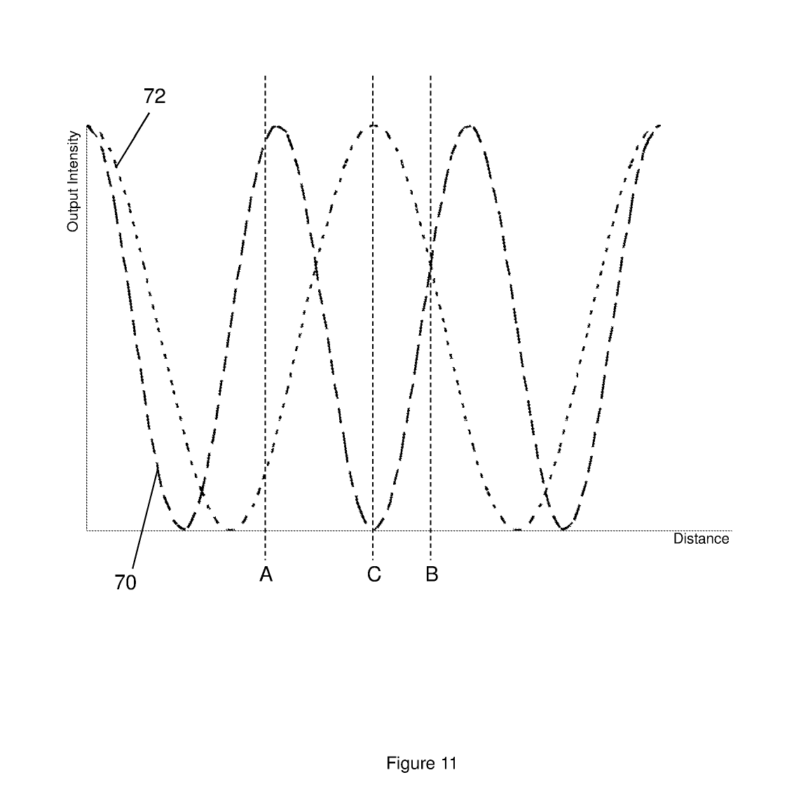

FIG. 11 illustrates the different effect on the output intensity for different wavelengths of light. The output intensities for two input wavelengths 70, 72 are shown (in arbitrary units) for different distances of travel through the LCP layer 24 (also in arbitrary units). In the example, the output intensity at the distance A is significantly greater for the first wavelength 70 than the second wavelength 72. The output for the distance B is approximately equal, and finally the output of the second wavelength 72 is significantly greater at the distance C.

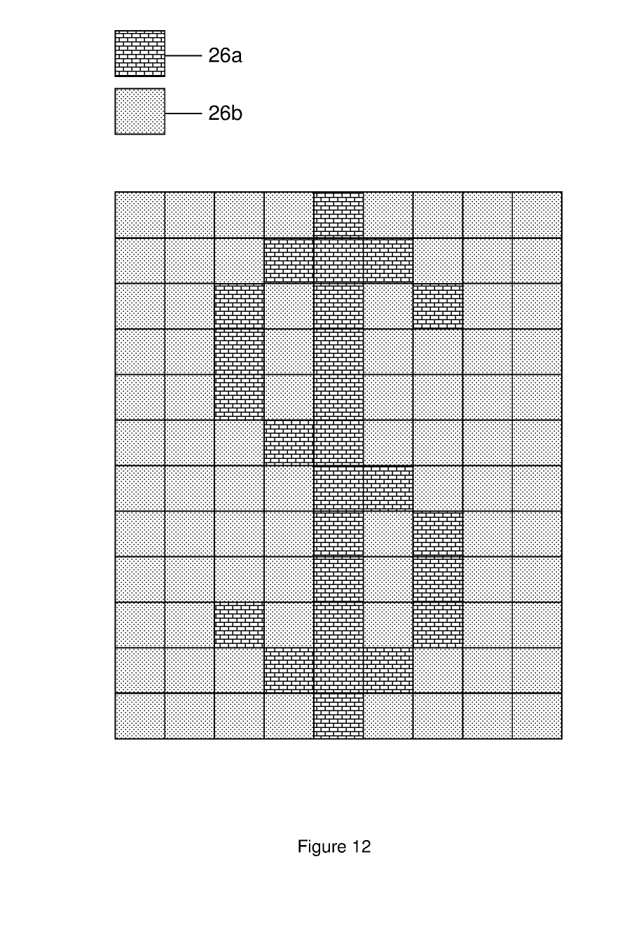

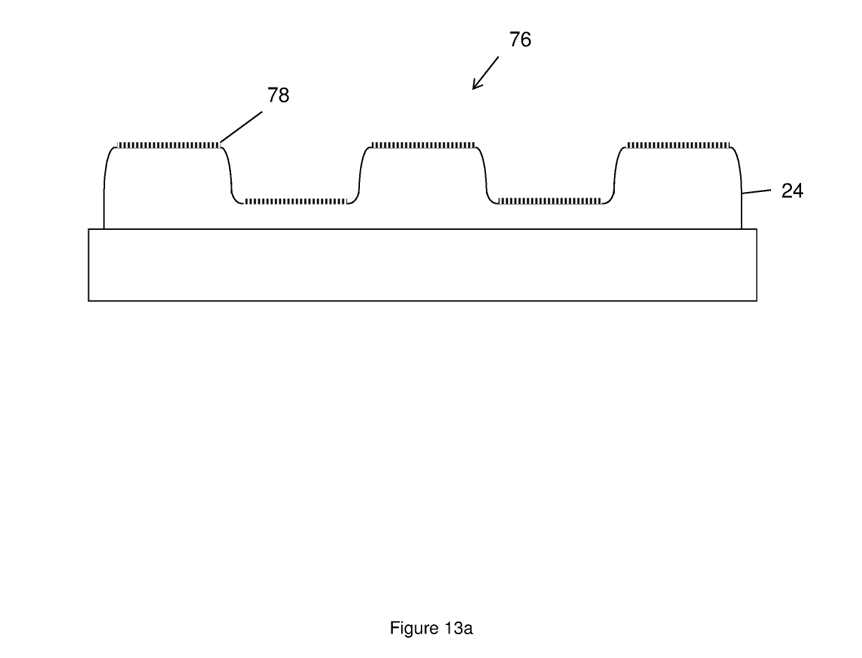

In general, where the input light is white light, the output light is coloured light, due to some wavelengths being blocked by the output polariser. Referring to FIG. 12, the output for different LCP regions 26a, 26b is chosen to appear as different colours (preferably colours that contrast well with each other), thus providing a two or more colour image as the hidden visual effect. As shown, an image of a dollar sign can be created by selective arrangement of first and second types of LCP region 26a, 26b. Adjacent LCP regions 26a or 26b with the same LCP profile can be considered as separate LCP regions 26a or 26b (i.e. pixels) or as one LCP region 26a or 26b.

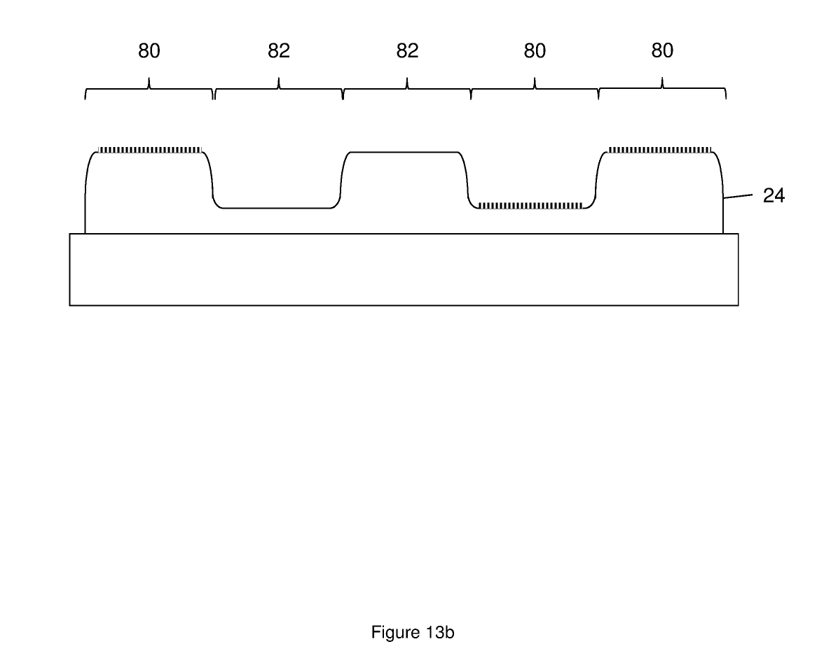

Further embodiments are described with reference to FIGS. 13a to 13b. These embodiments incorporate a surface structure onto the outward facing surface 76 (for convenience, the outward facing surface is simply referred to herein as LCP surface 76) of the LCP layer 24. A surface structure is one which includes at least regions which have a non-smooth profile, for example a grating suitable for creating a diffractive effect.

Referring to the embodiment of FIG. 13a, the entire extent of the LCP surface 76 of the LCP layer 24 includes a surface structure (optionally excluding the transition edges between different LCP regions 26a, 26b). The surface structure corresponds to an arrangement of LCP grating elements 78, which correspond to projections (as shown) and/or depressions (not shown) formed onto the LCP layer 24. The LCP grating elements 76 are arranged with spacing and dimensions such as to provide a diffractive effect with respect to incident light. Other arrangements are also envisioned, including spacing and dimensions configured to provide a zero-order diffractive effect.

Referring to the embodiments of FIG. 13b, only a portion of the LCP surface 76 of the LCP layer 24 includes a surface structure. The surface structure includes LCP grating regions 80 and LCP non-grating regions 82. Similar to the embodiment of FIG. 13a, the LCP grating regions 80 include an arrangement of LCP grating elements 78. The LCP grating elements 78 within the LCP grating regions 80 are arranged with spacing and dimensions such as to provide a diffractive effect with respect to incident light. Again, other arrangements are also envisioned, including spacing and dimensions configured to provide a zero-order diffractive effect.

In the embodiment of FIG. 13b, the LCP grating regions 80 overlap with LCP regions 26a, 26b. Said another way, the LCP grating elements 78 overlap with the grating 16 formed onto the surface of the substrate 8. This will, in general, combine the visual effect described with reference to FIGS. 1 to 13b with the visual effect created by the LCP grating elements 78. In the figure, each of the LCP grating regions 80 and LCP non-grating regions 82 are entirely associated with the entire surface of a LCP region 26a, 26b. In a variation, the LCP grating regions 80 and LCP non-grating regions 82 are independent of the surface area of particular LCP regions 26a, 26b (for example, by way of illustration, a single LCP grating region 80 may overlap half, or one and one half, of a LCP region 26a, 26b).

In another embodiment, the grating 16 formed onto the substrate 8 is configured with grating regions and non-grating regions. The LCP grating regions 80 are configured to overlap with non-grating regions, and the LCP non-grating regions 82 are configured to overlap grating regions. The embodiment allows for, effectively, two separate optical effects associated with the optical device 4.

In a particular example of the above embodiments, one of the LCP regions 26 (for example, the one or more second LCP regions 26b) is configured to show no, or minimal, colour change when viewed through a polariser. This can be achieved by having a relatively small layer thickness. Instead, the one or more second LCP regions 26b are configured with a surface structure (the, or each of the, second LCP regions 26b corresponds to an LCP grating region 80), and the one or more first LCP regions 26a are configured without a surface structure (the, or each of the, second LCP regions 26b corresponds to an LCP non-grating region 82).

Further modifications and improvements may be incorporated without departing from the scope of the invention. For example, a reflective polariser can be employed as the verification polariser.

1.-58. (canceled)

59. An optical device, preferably a security device, including a relief structure formed on a substantially planar first surface of a substrate, the relief structure having a first alignment direction and including a plurality of relief structure elements and a liquid crystal polymer (LCP) layer applied to the relief structure such that the LCP layer is aligned with the relief structure, wherein the LCP layer includes at least one or more first LCP regions having a first height and a first thickness and one or more second LCP regions having a second height and a second thickness above the substantially planar first surface of the substrate, wherein the second height is different to the first height, and wherein the second thickness is different to the first thickness.

60. An optical device as claimed in claim 59, wherein the, or each, first LCP region is associated with a first colour, and wherein the, or each, second LCP region is associated with a second colour, different to the first colour.

61. An optical device as claimed in claim 59, further including a high refractive index (HRI) layer applied to the LCP layer.

62. An optical device as claimed in claim 61, wherein the HRI layer extends past the edges of the LCP layer.

63. An optical device as claimed in claim 61, wherein the HRI layer includes a substantially flat outward facing surface.

64. An optical device as claimed in claim 61, wherein the HRI layer is selected to have a refractive index the same as, or substantially the same as, the ordinary refractive index of the LCP layer.

65. An optical device claimed in claim 61, wherein the HRI layer is selected to have a refractive index the same as, or substantially the same as, the extraordinary refractive index of the LCP layer.

66. An optical device as claimed in claim 61, wherein the HRI layer is selected to have a refractive index between the ordinary and extraordinary refractive indices of the LCP layer.

67. An optical device as claimed in claim 61, wherein the HRI layer is selected to have a refractive index substantially greater than the largest refractive index of the LCP layer.

68. An optical device as claimed in claim 59, wherein the substrate includes an embossing layer corresponding to the relief structure.

69. An optical device as claimed in claim 68, wherein the embossing layer includes a radiation curable ink.

70. An optical device as claimed in claim 59, wherein the liquid crystal polymer layer is applied using a printing process, preferably selected from gravure printing, intaglio printing, offset printing, silk screen printing, or inkjet printing.

71. An optical device as claimed in claim 59, wherein each relief structure element is longitudinally extending and arranged parallel to each other.

72. An optical device as claimed in claim 59, wherein the substrate is transparent and including a first linear polariser located on a second surface of the substrate, opposite the LCP layer.

73. An optical device as claimed in claim 72, wherein the linear polariser has a polarising direction aligned at substantially 45 degrees with respect to the first alignment direction.

74. An optical device as claimed in claim 59, wherein the LCP layer includes one or more structured regions, wherein the, or each, structure region includes a grating profile formed on the outward facing surface of the LCP layer.

75. An optical device as claimed in claim 74, wherein the relief structure includes one or more non-relief regions, and wherein the structured regions are located overlapping the, or each of the, one or more non-relief regions.

76. An optical device as claimed in claim 74, wherein the grating profile is configured to provide a diffractive effect.

77. A security document, preferably a banknote, including a document substrate including an optical device according to claim 59 in a region of the document substrate.

78. A security document as claimed in claim 77, including a first opacifying layer applied to a side of the document substrate, the first opacifying layer including a window region such that the optical device is located in the window region.

79. A security document as claimed in claim 77, including a polariser formed in a region of the document substrate different to the location of the optical device, such that the optical device can be viewed through the polariser by twisting, folding, or other manipulation of the document substrate.

80. A method for producing an optical device, preferably a security device, including the steps of:
a. forming a relief structure on a substantially planar first surface of a substrate, the relief structure having a first alignment direction and including a plurality of relief structure elements; and
b. applying a liquid crystal polymer (LCP) layer onto the relief structure such that the LCP layer is aligned with the relief structure,
wherein the LCP layer includes at least one or more first LCP regions having a first height and a first thickness and one or more second LCP regions having a second height and a second thickness above the substantially planar first surface of the substrate, wherein the second height is different to the first height, and wherein the second thickness is different to the first thickness.
